(19) United States
(12) Patent Application Publication
(10) Pub. No.: US 2005/0034261 A1
(43) Pub. Date: Feb. 17, 2005

(54) Paint roller and kit

(76) Inventor: John S. Capoccia, Galena, OH (US)

Correspondence Address: Jerry K. Mueller, Jr.;Mueller and Smith, LPA, 7700 Rivers Edge Drive, Columbus, OH, 43235, US

(21) Appl. No.: 10/921,028

(22) Filed: Aug. 18, 2004

Related U.S. Application Data
(63) Continuation-in-part of application No. 09/892,001, filed on Jun. 26, 2001, now abandoned.
Application No. 09/892,001 is a continuation-in-part of application No. 09/803,463, filed on Mar. 9, 2001, now Pat. No. 6,289,548.
Application No. 09/803,463 is a continuation of application No. 09/344,479, filed on Jun. 25, 1999, now abandoned.

(51) Int. Cl. B05C 17/02

(52) U.S. Cl. 15/230.11; 15/257.06; 492/13; 492/19

(57) ABSTRACT

Broadly, a paint roller kit includes a paint roller formed from an annular applicator, which surmounts a single interior annular core. The applicator has a central valley for forming a pair of spaced-apart applicator heads. Each applicator head is capable of being simultaneously dipped into different colored paint for creating two-color paint finishes. Advantageously, the applicators are spaced-apart to reveal the core. Preferably, the thickness of each of the applicator heads is at least about 0.5 inches and can range upwards to at least about 0.75 inches or more and be quite useful in use. The paint roller kit also includes a roller pan having a central divider for forming a pair of paint reservoirs adapted to be simultaneously accessed by the applicator heads. The depth of the valley is at least as great as the height of the pan divider.

### CROSS-REFERENCE TO RELATED APPLICATIONS

This application is a continuation-in-part of application serial no. 09/892,001, filed Jun. 26, 2001; which is a continuation-in-part of application serial no. 09/803,463, filed Mar. 9, 2001, now U.S. Pat. No. 6,289,548; which application is a continuation of application Ser. No. 09/344,479, filed Jun. 25, 1999, now abandoned. The disclosures of these applications are expressly incorporated herein by reference.

### STATEMENT REGARDING FEDERALLY SPONSORED RESEARCH

Not applicable.

### BACKGROUND OF THE INVENTION

The present invention generally relates to tools used in the creation of two-color paint finishes, e.g., faux paint finishes, and more particularly to a dual-head paint roller mounted on a single core.

Broken pattern surface-coatings were popular in the 1930's. They were produced by techniques known as“ragging on” and“sponging” and which involved a rag or sponge that was used to disturb a freshly painted wall to produce a broken pattern. Considerable skill was required to produce an aesthetically pleasing affect.

Today, such specialty finishes can involve more than one color of paint in order to create a look that otherwise is only available from expensive wall coverings. One such technique involves the application of a base coat of one paint and the selective application of a different color topcoat that can be applied by rag or sponge rolling. Alternatively, a top coat can be applied over a dried base coat and some of the top coat removed with a rag, sponge, cheese cloth, or other tool to create the specialty finish desired. U.S. Pat. Nos. 4,930,179 and 5,206,979 are examples thereof. In fact, it even has been proposed to use a bifurcated roller to apply two different colors at the same time in U.S. Pat. Nos. 5,713,095 and 5,970,568. A rag wrapped around a tube is another tool proposed in U.S. Pat. No. 5,471,703.

In particular the bifurcated roller of U.S. Pat. No. 5,713,095 has a single handle from which a pair of stiff wires project forwardly to a 90° bend. Each separate bend mounts a roller. In this fashion, paint roller pants having a central divided and filled with two colors of paint can be accessed at the same time with each roller in different color paints. The bifurcated roller in U.S. Pat. No. 5,970,568 utilizes a single bend and two different rollers separated by a V-shaped medial frame. The invention is a basic improvement to these concepts.

### BRIEF SUMMARY OF THE INVENTION

Broadly, a paint kit includes a paint roller formed with an annular applicator, which desirably surmounts a single interior annular core. The applicator has a central valley for forming a pair of spaced-apart applicator heads. Each applicator head is capable of being simultaneously dipped into different colored paint for creating two-color paint finishes. Advantageously, the applicators are spaced-apart to reveal the core, are spaced-apart by an annular spacer, or are otherwise kept apart. Preferably, the thickness of each of the applicator heads is at least about 0.5 inches and can range upwards to at least about 0.75 inches or more and be quite useful in use. The paint roller mounted to a handle, which desirably is hand-graspable. The construction of the paint roller assembly, then, includes a handle assembly that includes a rotatable cage upon which the paint roller head (annular core surmounted by an applicator head) is press fitted over.

The paint roller kit also includes a roller pan having a central divider for forming a pair of paint reservoirs adapted to be simultaneously accessed by the applicator heads. The depth of the valley is at least as great as the height of the pan divider.

Advantages of the present invention include a paint roller kit that is quite economical to manufacture. Another advantage is a paint roller kit that can be adapted to virtually any type of applicator material. A further advantage is a paint roller in the kit than can retain more paint for application to walls. Yet another advantage is a paint roller kit wherein the bifurcated pan is designed to accommodate the dual applicator head paint roller. These and other advantages will be readily apparent to those skilled in the art based on the present disclosure.

### BRIEF DESCRIPTION OF THE DRAWINGS

For a fuller understanding of the nature and objects of the present invention, reference should be made to the following detailed description taken in conjunction with the accompanying drawings, in which like reference numerals refer to like elements throughout, and in which:

FIG. 1 is a perspective view of the novel paint roller wherein its center removed to create a pair of smaller paint applicator heads separated by a valley and supported on a single central core (tube) or each applicator head supported by their own central core;

FIG. 2 is a side elevational view of the novel paint roller mounted on a paint roller handle and frame;

FIGS. 3A and 3B are side elevational views of the paint roller of FIG. 1 wherein the core is visible at the bottom of the central valley;

FIG. 4 is a side elevational view of the paint roller of FIG. 1 with one of the roller heads cut away to reveal the frame or cage of the handle assembly;

FIG. 5 is a side elevational view of the novel paint roller with wool head material and a foam interior core; and

FIG. 6 is a perspective view of the bifurcated paint pan, which, with the novel roller, forms the kit of the present invention.

The drawings will be described in detail below.

### DETAILED DESCRIPTION OF THE INVENTION

Two color paint patterns advantageously can be applied to walls using the inventive roller and kit. Cost considerations dictate that the two roller applicators be manufactured as economically as possible. The invention has the ability to modify virtually any conventional paint roller to form the inventive dual head, single core paint roller. It also can be custom manufactured.

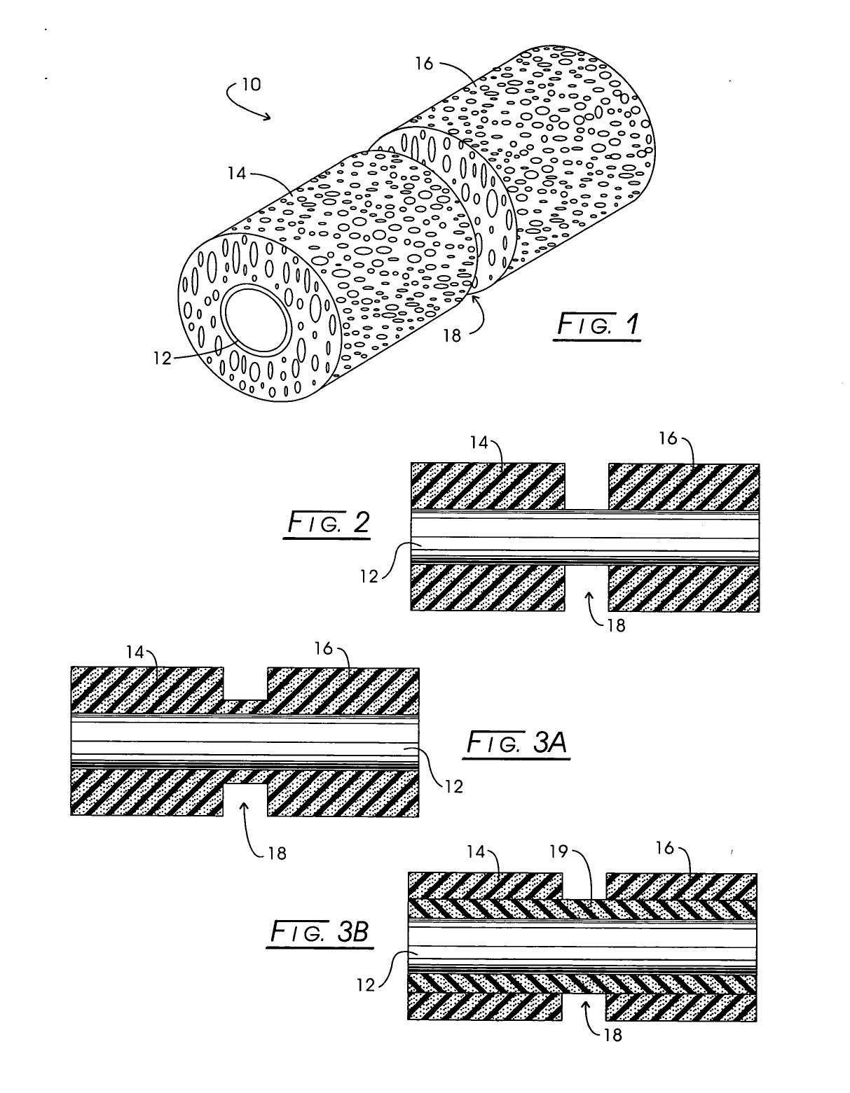

In this regard, FIG. 1 illustrates an exemplary such dual head, single core paint roller, 10. A single core, 12, is seen surmounted by a pair of applicator heads, 14 and 16. A valley, 18, separates applicator heads 14 and 16. Now, paint roller 10 could start as a conventional paint roller with continuous annual head mounted on core 12. Material then can be removed to form valley 18, which may be of any convenient shape, including, for example, rectangular or triangular in cross-section. The amount of material removed can be complete to reveal core 18 or incomplete to reveal material from which the annual roller is made. The depth of valley 18 is controlled by the amount of material removed. Alternatively, paint applicator head material could be adhesively or otherwise mounted onto core 12 for forming applicator heads14 and 16.

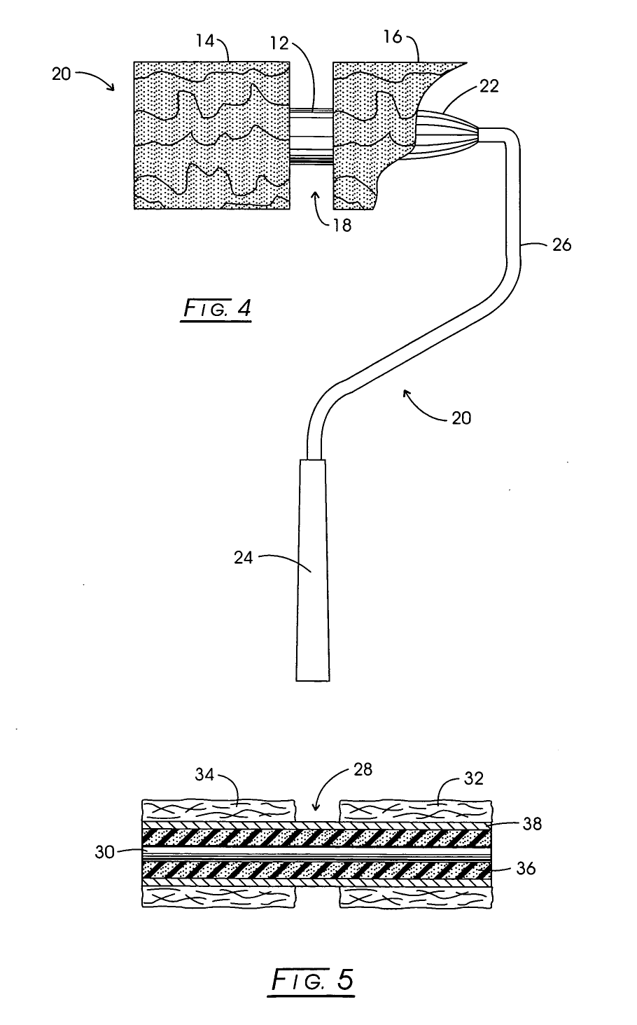

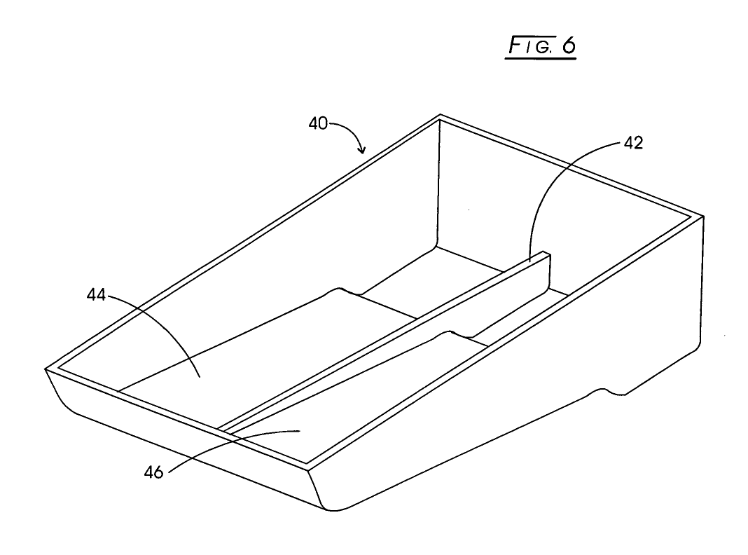

In this regard, reference is made to FIG. 2 and FIGS. 3A and 3B. In FIG. 2, it will be seen that forming applicator heads 14 and 16 are spaced apart to reveal core 12. Applicator heads 14 and 16 in FIG. 2 also have their outer edges beveled to reduce tracking. In FIG. 3A which conveniently is made by removal of material from a conventional paint roller head, it will be seen that insufficient material was removed in forming applicator heads 14 and 16 to reveal core 12, thus the material forming the applicator heads still is seen in the bottom of valley 18. In FIG. 3B, material has been removed from applicator heads 14 and 16 to form separate annular heads. In this case, however, inner annular layer 19 surmounts core 12 and is revealed in valley 18. This embodiment illustrates the ability to use multiple materials in forming roller 10. In particular, layers of different materials having different properties (e.g., density, hardness, cost, etc.) can be used to achieve, for example, special affects, to reduce manufacturing costs, or the like. In particular inner annular layer 19 could be more compressible than applicator heads 14 and 16 for enabling roller 10 to conform to, for example, an interior corner for deposit of paint in the interior corner. The embodiment in FIG. 5 is similar in construction, as its description will reveal.

These design factors also can be seen in FIG. 4 wherein roller 10 is seen mounted on a handle assembly, 20. Valley 18 is revealed along with applicator heads 14 and 16. In particular, applicator head 16 and annular core 12 have been cut away to reveal a rotating cage or frame, 22, of handle assembly 20. Such construction of handle assembly 20 is conventional. Thus, the roller/handle assembly combination in FIG. 4 has, from outside to inside, applicator head 16, annular core 12, cage 22. Such construction necessarily results in applicator heads 14 and 16 turning at the same rate because rotation of roller 10 results solely from rotation of cage 22.

Handle assembly 20 is conventional in construction, which contributes to the favorable economics in manufacturing the inventive paint roller. Handle assembly 20 is formed from a hand-graspable handle, 24, and a wire extension, 26, and cage 22. Again, the manufacturing economics are favorable. To the consumer/user, the handle assembly with paint roller is conventional in arrangement, which means that the user will feel comfortable with it. Rotation of with applicator heads 14 and 16, and annular core 12, then, results from the rotational mounting of cage 22 to wire extension 26 of handle assembly 20.

While there are certain advantages to having both applicator heads 14 and 16 supported by a single annular core (core 18), it is entirely possible to have each applicator head supported by its own annular core. In such case a spacer inserted over cage 22 could create valley 18 or the tension created by cage 22 could be sufficient to retain each separate roller head and core in spaced-apart relationship from each other with the need for a spacer. For that matter, the user also could use a handle assembly having two different spaced-apart cages for each applicator head.

The paint roller head depicted in FIG. 5 is especially adapted for lambs wool (real or synthetic) rollers, but it can be adapted for other paint applicator material, for example, mohair, rags, fleece, or the like. A wool roller head, 28, is constructed from an inner annular core, 30, and outer wool applicator heads, 32 and 34. Wool applicator heads 32 and 34 are not particularly resilient or elastic. Thus, interposed between heads 32/34 is an annular foam layer, 36, and outer secondary annular core, 38, which receives wool applicator heads 32 and 34. Annular foam layer 36 ensures that roller head 28 will confirm to uneven wall surfaces and will enable paint to be deposited into interior corners by the user pressing roller head 28 into the interior corner. Roller head 28 then can be rolled adjacent to the corner to smooth the paint pattern. Again, wool roller head 28 can be fit over cage 22 of handle assembly 20 and operated as described above.

Now, with conventional sponge roller heads, the user can push the roller head into a corner to deposit paint in the corner followed by smoothing the deposited paint with the roller in conventional fashion. With the use of the inner annular foam layer as described in connection with FIG. 5, the user can now apply the same interior corner painting technique using a wools or similar material roller. Annular foam core 36 permits the roller head to be squeezed into and conform to the interior corner to deposit paint held by wool rollers 32/34 followed by smoothing the paint with roller head 28 in conventional fashion.

Moreover, the use of a separate interior annular foam core permits the use of the same density (elasticity) foam for the applicator head or a different density (elasticity) applicator head. Perhaps, the annular foam core could be less expensive material with higher performance and cost material reserved for the outer annular applicator head. A variety of design concepts now are open to the paint roller designer with such construction technique.

The dual head, single core paint rollers disclosed herein are designed for use with a paint roller pan, 40, illustrated in FIG. 5. Roller pan 40 is conventional in construction, but for a central divider wall, 42, which forms a pair of elongate, adjacent paint reservoirs, 44 and 46. It will be observed that the height of divider wall 42 is matched to the depth of valley 18. That is, the height of divider wall 42 should not exceed the depth of valley 18, so that each applicator head 14 and 16 can rest on the floor of each paint reservoir 44 and 46. If the height of divider wall 42 were greater than the depth of valley 18, then roller 10 would teeter back and forth on segment 22 as a pivot. While this teetering can be present and each reservoir 44 and 46 accessed on separate movements of the applicator heads, such dual movement to load roller 10 is waste of time and effort and likely will be rejected by astute users compared to a design of a lower dividing wall 10 as described above.

Virtually any material can be used in forming applicator heads 14 and 16. Such materials include, inter alia, synthetic and natural fibers, including, for example, open and closed foams, mohair, wool, rubber, rags, fleece, plastics, wood, and the like. Depending upon the material used and other factors, the novel roller can be manufactured in its disclosed structure. Alternatively, a conventional, e.g., sponge roller can have material removed at its center to form valley 18 by cutting, grinding, or other removal techniques.

Synthetic sponges may be formed from polyurethane, polyether, polyester, or like elastomer that is suitable for making a sponge product. Open cell foamed products can be made with suitable blowing agents and by other techniques commercially practiced in a variety of art fields. The degree of elasticity may vary from manufacturer to manufacturer. Indeed, a variety of elasticity's may function effectively for making the inventive torn patterned open cell synthetic sponge roller heads of the present invention. Of course, if use of the torn patterned open cell synthetic sponge roller head is for stippling topping compound, stiffer foam would be desired than if faux painting were being done. Those skilled in the art will appreciate and be able to select the desired degree of elasticity desired of the torn patterned open cell synthetic sponge roller head depending upon the use being made thereof.

The applicator heads can contain patterns for create special affects, such as disclosed in the background art and in the parent applications cited above. In this regard, advantageously, such patterns can have any depth, but certain advantages can be realized if the depth ranges from about 0.5 to 0.75 or more inches. Such extra deep patterns avoid the pattern grooves from becoming full of paint or loading up which phenomenon results in an ineffective pattern at best being transferred to the wall surface.

When transferring a pattern to a painted wall, the painter cannot overlap each adjacent rolled area at the risk of destroying part of the pattern already laid down. To avoid leaving a “track” or ridge of paint that must be smoothed over with each adjacent area being painted, then, the inventive rollers have their edges beveled. Such edge beveling permits the painter to place each adjacent pattern directly in abutting juxtaposition with each adjacent pattern without overlapping the prior pattern.

Substrates that can be painted and/or decorated by the novel rollers include interior and exterior surfaces, such as, for example, fiberboard, drywall, plaster, masonry, concrete block, unglazed brick, cement brick, metals (e.g., aluminum, steel, galvanized steel, structural steel, ornamental iron), wood, stucco, hardboard, oriented strand board, and the like. Such materials can form interior and exterior walls, floors, ornamental structures, and the like. Accordingly, there are no known limitations on substrates that can be painted using the inventive roller with proper selection of materials of construction.

The same can be said of the paint in that there are no known limitations on the types or kinds of paints that can be used. In this regard, conventional paints include, inter alia, acrylics, alkyds, rubbers, epoxies, urethanes, ureas, polyesters, phenolics, silicones, vinyls, and the like. While the same paint or same color paint can be placed in each reservoir, often a different color, gloss, base (water based, oil based), tint, etc., paint will be placed in each reservoir.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

1. A paint roller kit, which comprises:
(a) a paint roller, which comprises a single interior annular core surmounted by two, spaced-apart paint applicator heads having a central valley therebetween, said paint applicator heads being formed from paint applicator head material, said interior annular core adapted to surmount a cage of a handle assembly, each applicator head having a thickness of at least about 0.5 inches; and
(b) a roller pan having a central divider wall for forming a pair of paint reservoirs adapted to be simultaneously accessed by the applicator heads, wherein the depth of the central valley is at least about as great as the height of the pan divider wall,
whereby each said applicator head is capable of being simultaneously dipped into different colored paint housed in said paint reservoirs for creating two-color paint finishes.

2. The paint roller kit of claim 1, wherein the outer edges of each applicator head are beveled.

3. The paint roller kit of claim 1, wherein said paint applicator head independently is one or more of an elastomer foam, mohair, wool, rubber, rags, fleece, plastic, or wood.

4. The paint roller kit of claim 3, wherein said elastomer is one or more of polyurethane, polyester, or polyether.

5. The paint roller kit of claim 4, wherein said elastomer bears a pattern.

6. The paint roller kit of claim 5, wherein said valley ranges down to said core.

7. The paint roller kit of claim 1, wherein said valley does not range down to said core.

8. The paint roller kit of claim 1, wherein said paint roller is mounted on the cage of a paint roller handle assembly.

9. The paint roller kit of claim 1, wherein each applicator head has a thickness of at least about 0.75 inches.

10. A dual head paint roller adapted to surmount a cage of a handle assembly, which comprises:
a single interior annular core surmounted by two, spaced-apart paint applicator heads having a central valley therebetween and being formed from paint applicator head material, and adapted to surmount a cage of a handle assembly, each applicator head having a thickness of least about 0.5 inches.

11. The dual head paint roller of claim 10, wherein the outer edges of each applicator head are beveled.

12. The dual head paint roller of claim 10, wherein said paint applicator head independently is one or more of an elastomer foam, mohair, wool, rubber, rags, fleece, plastic, or wood.

13. The dual head paint roller of claim 12, wherein said elastomer is one or more of polyurethane, polyester, or polyether.

14. The dual head paint roller of claim 13, wherein said elastomer bears a pattern.

15. The dual head paint roller of claim 10, wherein said valley ranges down to said core.

16. The dual head paint roller of claim 10, wherein said valley does not range down to said core.

17. The dual head paint roller of claim 10, wherein said paint roller is mounted on the cage of a paint roller handle assembly.

18. The dual head paint roller of claim 10, wherein each applicator head has a thickness of at least about 0.75 inches.

19. The dual head paint roller of claim 10, wherein an interior annular foam layer is interposed between said applicator heads and said core.

20. The dual head paint roller of claim 19, wherein said applicator heads are formed from one or more of wool, mohair, rags, or fleece.

21. The dual head paint roller of claim 14, wherein the pattern ranges in depth from about 0.5 inches to about 0.75 inches.

22. A paint roller adapted to surmount a cage of a handle assembly, which comprises:
an interior annular core surmounted by a paint applicator head formed from paint applicator head material and adapted to surmount a cage of a handle assembly, said head having a thickness of at least about 0.5 inches.

23. The paint roller of claim 22, wherein the outer edges of said applicator head is beveled.

24. The paint roller of claim 22, wherein said paint applicator head is formed from one or more of an elastomer foam, mohair, wool, rubber, rags, fleece, plastic, or wood.

25. The paint roller of claim 24, wherein said elastomer is one or more of polyurethane, polyester, or polyether.

26. The paint roller of claim 25, wherein said elastomer bears a pattern.

27. The paint roller of claim 22, wherein said paint roller is mounted on the cage of a paint roller handle assembly.

28. The paint roller of claim 22, wherein said applicator head has a thickness of at least about 0.75 inches.

29. The paint roller of claim 22, wherein an interior annular foam layer is interposed between said applicator heads and said core.

30. The paint roller of claim 29, wherein said applicator heads are formed from one or more of wool, mohair, rags, or fleece.

31. A paint roller adapted to surmount a cage of a handle assembly, which comprises:
an interior annular core surmounted by a paint applicator head formed from paint applicator head material and adapted to surmount a cage of a handle assembly, and an interior annular foam layer interposed between said applicator heads and said core.

32. The paint roller of claim 31, wherein the outer edges of said applicator head is beveled.

33. The paint roller of claim 31, wherein said paint applicator head is formed from one or more of an elastomer foam, mohair, wool, rubber, rags, fleece, plastic, or wood.

34. The paint roller of claim 33, wherein said elastomer is one or more of polyurethane, polyester, or polyether.

35. The paint roller of claim 34, wherein said elastomer bears a pattern.

36. The paint roller of claim 31, wherein said paint roller is mounted on the cage of a paint roller handle assembly.
